(19) United States
(12) Patent Application Publication
(10) Pub. No.: US 2007/0178905 A1
(43) Pub. Date: Aug. 2, 2007

(54) METHOD OF CALL TRANSFER BETWEEN WIRELESS LOCAL AREA NETWORKS CONNECTED TO A MOBILE NETWORK, AND ASSOCIATED MANAGEMENT DEVICE

(75) Inventors: Yacine El Mghazli, Arcueil (FR); Olivier Marce, Massy (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/620,956

(22) Filed: Jan. 8, 2007

(30) Foreign Application Priority Data
Jan. 10, 2006 (FR) 0650090

(51) Int. Cl. H04Q 7/20

(52) U.S. Cl. 455/445

(57) ABSTRACT

A method is dedicated to call transfer between first and second WLAN using a wireless access technology and respective first and second secure gateways connected to a core network of a network offering packet-switched services. This method consists in, when a call has been set up between a mobile communication terminal and the core network via a first secure tunnel set up within the first WLAN network connected through to the first secure gateway and associated with authentication and security data, and if the mobile terminal enters a radio overlap area of the first and second wireless local area networks, i) pre-authenticating the mobile terminal, at the level of an IP layer, vis à vis the second security gateway, via the first tunnel, and using the authentication and security data, ii) then setting up a second secure tunnel between the mobile terminal and the second security gateway, iii) then updating mobility management information via the second tunnel, iv) then proceeding to the transfer between wireless local area networks by sending the second security gateway, via the second tunnel, a peer address updating message in respect of the mobile terminal, and v) continuing the call via the second tunnel.

### CROSS-REFERENCE TO RELATED APPLICATIONS

This application is based on French Patent Application No. 0650090 filed on Jan. 10, 2006, the disclosure of which is hereby incorporated by reference thereto in its entirety, and the priority of which is hereby claimed under 35 U.S.C. §199.

### BACKGROUND OF THE INVENTION

1. Field of the Invention

The invention relates to communication networks, and more precisely interworking (IW) between wireless local area networks (WLAN) using a wireless access technology protected by IPsec type secure tunnels and core networks, for example Internet or mobile (or cellular) network defined by the 3GPP (2G/3G) organization.

2. Description of the Prior Art

As the man skilled in the art knows, certain wireless local area networks (WLAN), for example WiFi and WiMax networks, use a wireless access technology protected by IPsec type secure tunnels enabling them to use the core network infrastructures of certain networks, for example 3GPP (for example UMTS) mobile networks. This enables customers of these WLAN networks to access 3GPP packet-switched services via wireless access networks protected by IPsec type secure tunnels.

The 3GPP organization has proposed two interworking solutions, called I-WLAN (Interworking-WLAN) and GAN (Generic Access Network), integrated into the 3GPP standard after being developed independently under the abbreviation UMA (Unlicensed Mobile Address). The GAN solution is defined on the 3GPP site at the Internet address “http://www.3gpp.org” and the UMA technology is defined at the Internet address “http://www.umatechnology.org”. Using each of these two solutions necessitates the installation of interconnection equipment, of security gateway (SecGW) type at the interface between the wireless access network of a WLAN network and the infrastructures of the core network of a mobile network, as well as the setting up of an IPsec tunnel type secure logical connection (IP secure tunnel) between each mobile communication terminal of a WLAN network customer wishing to access the packet-switched 3GPP services of the mobile network and said security gateway.

These two solutions work well provided that a mobile communication terminal uses the same WLAN network and therefore the same security gateway to access the 3GPP packet-switched services of a mobile network. However, each time that a mobile communication terminal leaves the radio coverage area of a first WLAN network (that has enabled it to access the 3GPP packet-switched services of a mobile network) and enters the radio coverage area of a second WLAN network having a security gateway different from that of the first WLAN network, a new IP secure tunnel must be set up between that mobile terminal and the security gateway of the second WLAN network. Such a situation arises, for example, if the user of a mobile terminal has a contract enabling him to use a plurality of WLAN networks (and in particular enabling roaming—a special case of interoperator mobility).

Now, the time to set up a new IP secure tunnel is incompatible with the concept of continuity of service, as defined by the ITU G.114 standard, for example. In other words, the I-WLAN and GAN solutions proposed by the 3GPP do not enable continuity of service to be maintained when a mobile terminal moves from a first WLAN network, with a first security gateway, to a second WLAN network, with a second security gateway.

### SUMMARY OF THE INVENTION

An object of the invention is therefore to improve upon this situation, and more precisely to enable continuity of service to be maintained when a mobile terminal moves from one WLAN network to another (including when the two WLAN networks belong to the same operator).

To this end it proposes a method dedicated to transferring a call between first and second wireless local area networks each using a wireless access technology and respective first and second secure gateways connected to a core network of a network (where applicable a mobile network) offering packet-switched services (where applicable 3GPP packet-switched services).

This method consists in, when a call has been set up between a mobile communication terminal and the core network via a first secure tunnel set up within the first wireless local area network between the mobile terminal and the first secure gateway and associated with authentication and security data, and if the mobile terminal enters an area of intersection between the radio coverage areas of the first and second wireless local area networks:
effecting a procedure of pre-authentication of the mobile terminal, at the level of the IP layer, vis à vis the second security gateway, via the first secure tunnel, and using the same authentication and security data,
then setting up a second secure tunnel between the mobile terminal and the second security gateway,
then effecting an updating of mobility management information via the second secure tunnel,
then proceeding to the transfer (or handover) between wireless local area networks by sending the second security gateway, via the second secure tunnel, a peer address updating message in respect of the mobile terminal, and
authorizing between the mobile terminal and the core network the call to continue via the second secure tunnel.

The method according to the invention may have other features and in particular, separately or in combination:
the pre-authentication procedure may be effected by means of a communication protocol dedicated to the creation of security associations, for example the IKE protocol (preferably in its second version (IKEv2));
the transmission of the peer address update message, via the second secure tunnel, may be effected by means of an extension of the communication protocol, dedicated to mobility and to multi-homing, for example the MOBIKE protocol extension.

The invention also proposes a device dedicated to managing call transfer between first and second wireless local area networks each using a wireless access technology and respective first and second secure gateways connected to a core network of a network (where applicable a mobile network) offering packet-switched services (where applicable 3GPP packet-switched services), in a mobile communication terminal including at least one layer 2 interface adapted, in the event of activation, to control transfers (or handovers) between wireless local area networks.

This device comprises
detection means adapted, when a call has been set up between the mobile terminal and the core network via a first secure tunnel set up within the first wireless local area network between the mobile terminal and the first secure gateway and associated with authentication and security data, to generate a warning message if the mobile terminal enters an area of intersection between radio coverage areas of the first and second wireless local area networks, and
management means adapted, in the event of reception of a warning message:
   to trigger a procedure of pre-authentication of the mobile terminal, at the level of the IP layer, vis à vis the second security gateway, via the layer 2 interface and the first secure tunnel, and with the authentication and security data,
   then to instruct, firstly, the setting up of a second secure tunnel between the mobile terminal and the second security gateway, secondly, updating of mobility management information via the second secure tunnel, and, thirdly, activation of the layer 2 interface so that it proceeds to the transfer (or handover) between the first and second wireless local area networks by sending the second security gateway, via the second secure tunnel, a peer address updating message in respect of the mobile terminal,

then to authorize the call between their mobile terminal and the core network to continue via the second secure tunnel when the transfer (and therefore the handover) has been completed.

The invention further proposes a mobile communication terminal adapted to be connected to wireless local area networks using a wireless access technology to set up calls with a core network of a network (where applicable a mobile network) offering packet-switched services (where applicable 3GPP packet-switched services) and connected to said wireless local area networks, and comprising at least one layer 2 (L2) interface and a management device of the type described hereinabove.

This mobile terminal may be adapted to effect each pre-authentication procedure vis à vis a security gateway instructed by its management device by means of a communication protocol dedicated to the creation of security associations, for example the IKE protocol.

Moreover, the mobile terminal may be adapted to transmit each peer address updating message by means of an extension of the communication protocol dedicated to mobility and to multi-homing, for example the MOBIKE protocol extension.

The invention is particularly well adapted, although not exclusively so, to interworking between WiFi or WiMax type wireless local area networks and 3GPP type mobile communication networks.

Other features and advantages of the invention will become apparent on examining the following detailed description and the appended drawings.

### BRIEF DESCRIPTION OF THE DRAWINGS

FIG. 1 shows very diagrammatically and functionally the connection of a mobile terminal (T1) equipped with a management device according to the invention to a core network of a mobile network via a first secure tunnel set up in a first wireless local area network,

FIG. 2 shows very diagrammatically and functionally the call transfer phase from the FIG. 1 mobile terminal (T1) of the first wireless local area network to a second wireless local area network when that mobile terminal (T1) is situated in the overlap area of the coverage areas of the first and second wireless local area networks.

FIG. 3 shows very diagrammatically and functionally a mobile terminal equipped with one embodiment of a management device according to the invention and a layer 2 (L2) interface.

### DETAILED DESCRIPTION OF THE PREFERRED EMBODIMENT

The appended drawings constitute part of the description of the invention as well as contributing to the definition of the invention, if necessary.

An object of the invention is to enable continuity of service to be maintained for a mobile terminal connected to a core network of a network (possibly a mobile network) via a secure tunnel set up in a first wireless local area network when it moves from the coverage area of said first wireless local area network to the coverage area of a second wireless local area network.

Hereinafter it is considered by way of nonlimiting example that the wireless local area networks are of WLAN type and that the core network connected to the WLAN networks is part of a mobile network, for example of UMTS type. However, the invention is not limited to this type of wireless local area network and to this type of mobile network. It relates in fact to all wireless local area networks using a wireless access technology protected by IPsec type secure tunnels and in particular Bluetooth, WiFi and WiMax networks, as well as all communication networks having a core network offering packet-switched (where applicable 3GPP) services and in particular 3GPP (2G/3G) mobile (or cellular) networks.

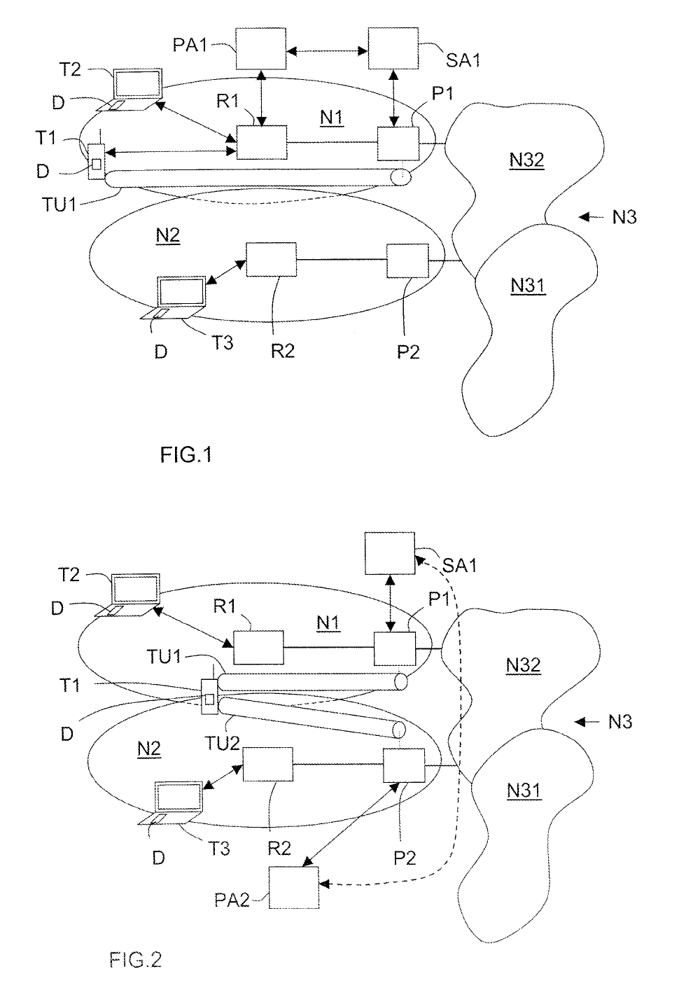

In the example shown in FIGS. 1 and 2, the first WLAN network N1 includes a first wireless access network (also referenced N1) and the second WLAN network N2 includes a second wireless access network (also referenced N2). Moreover, the mobile network N3 includes a radio access network N31 and a core network (of 3GPP WLAN IP Access) type N32 connected to each other.

Moreover, the first wireless access network N1 and the second wireless access network N2 include first and second secure gateways P1 and P2, respectively, each connected to the core network N32 of the mobile network N3 and providing interworking between their WLAN network N1, N2 and the mobile network N3.

The example shown in FIGS. 1 and 2 corresponds to a 3GPP/WLAN interworking architecture of I-WLAN type, as defined on the 3GPP Internet site at the address “http://www.3gpp.org”. However, the invention relates equally to the 3GPP/WLAN interworking architecture of GAN type, as defined on the 3GPP Internet site at the address “http://www.3gpp.org”.

The characteristics of 3GPP/WLAN interworking are defined by the recommendations and technical specifications 3GPP TR 23.934, TS 22.234, TS 23.234 and TS 24.234 of the 3GPP organization.

Furthermore, the first and second wireless access networks N1 and N2 each have a radio coverage area (here represented diagrammatically by an ellipse) provided with at least one radio access equipment (or access point) R1, R2 coupled to their security gateway P1, P2 and to which mobile communication terminals T1, T2 and T3 may be connected. The invention applies as soon as the radio coverage areas of the first and second wireless access networks N1 and N2 have an overlap area, as in the example shown in FIGS. 1 and 2.

It will be noted that the same equipment can provide simultaneously the access point R1 or R2 function and the security gateway P1 or P2 function.

“Mobile communication terminal” means any communication terminal that can be connected to a wireless access network N1, N2 in order to exchange data by radio, in the form of signals, with another user equipment or a network equipment, and the user whereof has entered into a contract with the operator of a WLAN network N1, N2 enabling him to use specific services offered by a mobile network when he is connected to its core network via a WLAN network. Thus it may be, for example, a mobile telephone, a personal digital assistant (or PDA) or a portable computer equipped with a WLAN communication device.

As the man skilled in the art knows, in order for a mobile terminal of the type cited above, for example T1, to be able to set up a call to the core network N32 of the mobile network N3 via a WLAN network (here the first one N1), in order to access at least one of the services that it offers, a secure tunnel TU1 must be set up between that mobile terminal T1 and the security gateway (here P1) of the (first) wireless access network (here N1). This secure tunnel is of the IPsec type.

Setting up this secure tunnel TU1 necessitates authentication beforehand of the user of the mobile terminal T1 by an authorization, authentication and accounting (AAA) type server SA1 of the first WLAN network N1 and by the first security gateway P1.

To be authenticated vis à vis the AAA server SA1, the mobile terminal T1 transmits to a network equipment PA1 of the AAA proxy type and connected to the AAA server SA1 authentication data, and where applicable security data, generally referred to as “EAP credentials”. This data consists, for example, of a password and/or a “login”. This transmission is effected by means of a transport and authentication protocol, for example the RADIUS or DIAMETER protocol.

The AAA proxy PA1 verifies vis à vis the AAA server SA1 if the authentication (and security) data transmitted correspond in fact to a customer authorized to access the services (for example of IMS type). If the customer has an authorization, his mobile terminal T1 is then registered with the AAA server SA1 and authorized to access the first WLAN network N1.

To be authenticated vis à vis the first security gateway P1 the mobile terminal T1 transmits to it its authentication (and security) data. This transmission is effected, for example, by means of a communication protocol dedicated to the creation of security associations, for example the IKE (Internet Key Exchange) protocol, preferably in its second version IKEv2 defined in the document “<draft-ietf-ispec-ikev2-17.txt>” available on the IETF site at the address “http://www.ietf.org/rfc/rfc4306.text”.

Once the authentications have been effected, a (first) secure tunnel TU1 of the IPsec type is set up between the layer 2 (L2) interface I1 (activated for this purpose) and the first security gateway P1. The mobile terminal T1 can then communicate with the core network N32 of the mobile network N3.

The invention is operative when a mobile terminal, for example T1, has already set up a call to a core network N32 of a mobile network N3 via a first secure tunnel TU1 set up within a first WLAN network N1 (between said mobile terminal T1 and the first secure gateway P1) with authentication and security data and enters the area of overlap (or intersection) between the radio coverage area of the first WLAN network N1 and that of a second WLAN network N2. In other words, the invention is operative each time that a mobile terminal, in communication with a core network of a mobile network, prepares itself to leave one WLAN network to continue its call in another WLAN network in the context of roaming. This situation is illustrated in FIG. 2.

The invention proposes to install in the mobile terminals T1 to T3, on the one hand, a device D responsible for managing the call transfer on moving from a first WLAN network N1 to a second WLAN network N2 and, on the other hand, at least one layer 2 (L2) interface responsible, in the event of activation, for monitoring the transfers between the WLAN networks N1 and N2.

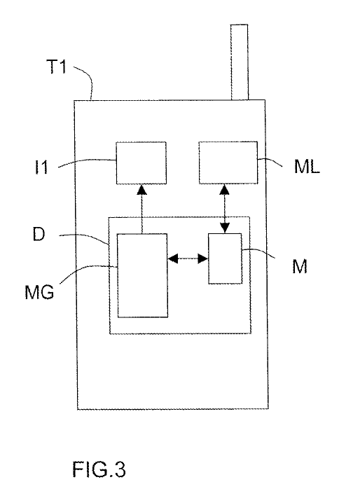

As shown diagrammatically in FIG. 3, this management device D comprises a detection module MD and a management module MG coupled to each other.

The detection module MD is responsible for observing the movements of the mobile terminal (for example T1) in which it is installed within the coverage areas of the WLAN networks N1, N2 to which it is authorized to be connected by virtue of its contract. To this end it is coupled to the module ML responsible for location in its mobile terminal T1, for example.

This observation is more precisely intended to detect when the mobile terminal T1 enters the area of overlap (or intersection) between the radio coverage areas of the first and second WLAN networks N1 and N2 and therefore when it is preparing to leave the first (respectively second) WLAN network to enter the second (respectively first) WLAN network.

Each time that the mobile terminal T1 has set up a call to the core network N32 of the mobile network N3 via a first secure tunnel TU1 set up in a first WLAN network N1 and the detection module MD detects its presence in an area of overlap between that first WLAN network N1 and a second WLAN network N2, said detection module MD generates a warning message to the management module MG in order to signal that presence to it. The warning message preferably includes data representing the second WLAN network N2 the coverage area whereof the mobile terminal T1 has just entered. That data comprises at least the address of the second access point R2 of the second WLAN network N2 and therefore includes indirectly the address of the second security gateway P2 of the second WLAN network N2.

Each time that it receives a warning message (generated by the detection module MD), the management module MG triggers a procedure of pre-authentication of its mobile terminal T1 vis à vis the AAA server SA1 of the first WLAN network N1 and the second security gateway P2 of the second WLAN network N2. This pre-authentication procedure is effected at the level of the IP protocol layer and via the first secure tunnel TU1. Remember that the IP protocol layer is situated above the level 2 layer (link layer L2). Moreover, this pre-authentication procedure is effected with the same authentication and security data (EAP credentials) as previously used for the initial authentication of the user of the mobile terminal T1 on setting up the first secure tunnel T1.

To be pre-authenticated vis à vis the AAA server SA1, the mobile terminal T1 transmits to the AAA proxy PA1 of the first WLAN network N1 the same authentication and security data (EAP credentials) as were used during the initial authentication procedure and the procedure for setting up the first secure tunnel TU1. This transmission is effected by means of the same transport and authentication protocol as used before (for example the RADIUS or DIAMETER protocol).

The AAA proxy PA1 then verifies vis à vis the AAA server SA1 if the authentication (and security) data transmitted actually correspond to a customer authorized to access the services. If the client has an authorization, his mobile terminal T1 is authorized to access the second WLAN network N2.

To be pre-authenticated vis à vis the second security gateway P2, the mobile terminal T1 transmits to it its authentication and security data (always the same). This transmission is preferably effected by means of the IKEv2 communication protocol.

All these operations are carried out during the call from the mobile terminal T1 via the first secure tunnel TU1 and therefore via the first security gateway P1. These operations are therefore carried out transparently for the user of the mobile terminal T1.

The invention utilizes the independence vis à vis the transport medium of the pre-authentication framework as defined by the IETF in its document “<draft-ohba-mobopts-mpa-framework-01.txt>” accessible on its site at the address “http://www.ietf.org/internet-drafts/draft-ohba-mobopts-mpa-framework-01.txt”.

When the pre-authentication operations have finished and the mobile terminal T1 has received the authorization to set up a second secure tunnel TU2, it forwards that authorization to the management module MG of its device D. The management module MG then instructs the setting up of a second secure tunnel TU2 between its mobile terminal T1 and the second security gateway P2 designated by the warning message previously received.

Once the second secure tunnel TU2 has been set up, the management module MG instructs its mobile terminal T1 to update mobility management information that relates to it in the core network N32 of the mobile network N3 via the second secure tunnel TU2. This consists mainly in updating in the core network N32 the location information for the mobile terminal T1, the type of access used, the access operator used, and the like. It then instructs its mobile terminal T1 to proceed to the handover at the level of the layer 2 (L2) interface I1 in order for the transfer between the first and second WLAN networks N1 and N2 to be effected via the second secure tunnel TU2.

More precisely, the handover procedure is effected by the mobile terminal T1 sending the second security gateway P2 of the second WLAN network N2 a peer address update message containing its new IP address in the second WLAN network N2. This peer address update message is transmitted to the second security gateway P2 by means of an extension of the communication protocol (here IKE, for example) that is dedicated to mobility and to multi-homing. For example, the protocol extension called MOBIKE may be used, as defined in the documents “<draft-ietf-mobike-design-03.txt>” and “<draft-ietf-ispec-mobike-protocol-04.txt>” accessible on the IETF site. Of course, the security gateway P2 must be able to support that extension.

The security gateway P2 of the second WLAN network N2 can then update the security data that is stored in its database dedicated to the security policy. Here this updating consists of storing the new address of the mobile terminal T1.

Once the updating of the security data has been effected, the handover is completed. The management module MG can then authorize its mobile terminal T1 to continue the call with the core network N32 of the mobile network N3 via the second secure tunnel TU2 and via the second security gateway P2. Remember that this call was up to this point set up via the first secure tunnel TU1 and via the first security gateway P1. There is therefore indeed continuity of service.

The management device D according to the invention, and in particular its detection module MD and its processing module MT, may be produced in the form of electronic circuits, software (or electronic data processing) modules or a combination of circuits and software.

It is important to note that if the mobile terminal T1 is adapted to have the benefit of optimization of the handover (inter-network transfer) mechanism at the level of the L2 layer, the optimized mechanism is automatically integrated into the processing offered by the invention in order to benefit from it (in fact it would be of no utility to improve layer 2 (L2) if the time gained at the IP level were lost).

Thanks to the invention, the time necessary for call transfer between wireless local area networks is significantly reduced. In fact it is primarily reduced to the handover delay of layer 2 (L2) (i.e. to the change of WLAN network at the level of the interface I1 because the whole of the IP plane is preconfigured beforehand).

The invention is not limited to the management device and mobile communication terminal embodiments described hereinabove by way of example only and encompasses all variants that the man skilled in the art might envisage that fall within the scope of the following claims.

There is claimed:

1. A method of transferring a call between first and second wireless local area networks using a wireless access technology and respective first and second secure gateways connected to a core network of a network offering packet-switched services, in which method, in the event of setting up a call between a mobile communication terminal and said core network via a first secure tunnel set up within said first wireless local area network between said mobile terminal and said first secure gateway and associated with authentication and security data, and if said mobile terminal enters an area of intersection between the radio coverage areas of said first and second wireless local area networks, i) effecting a procedure of pre-authentication of said mobile terminal, at the level of an IP layer, vis à vis said second security gateway, via said first secure tunnel, and using said authentication and security data, ii) then setting up a second secure tunnel between said mobile terminal and said second security gateway, iii) then effecting an updating of mobility management information via said second secure tunnel, iv) then proceeding to the transfer between wireless local area networks by sending the second security gateway, via said second secure tunnel, a peer address updating message in respect of the mobile terminal, and v) authorizing the call to continue via said second secure tunnel.

2. The method claimed in claim 1, wherein said pre-authentication procedure is effected by means of a communication protocol dedicated to the creation of security associations.

3. The method claimed in claim 2, wherein said communication protocol is a protocol called IKE.

4. The method claimed in claim 2, wherein said peer address updating message is transmitted by means of an extension of said communication protocol dedicated to mobility and to multi-homing.

5. The method claimed in claim 4, wherein said communication protocol extension is a protocol called MOBIKE.

6. A device for managing call transfer between first and second wireless local area networks using a wireless access technology and respective first and second secure gateways connected to a core network of a network offering packet-switched services, for a mobile communication terminal including at least one layer 2 interface adapted, in the event of activation, to control transfers between wireless local area networks, which device comprises i) detection means adapted, in the event of setting up of a call between said mobile terminal and said core network via a first secure tunnel set up within said first wireless local area network between said mobile terminal and said first secure gateway and associated with authentication and security data, to generate a warning message if said mobile terminal enters an area of intersection between radio coverage areas of said first and second wireless local area networks, and ii) management means adapted, in the event of reception of a warning message, to trigger a procedure of pre-authentication of said mobile terminal, at the level of an IP layer, vis à vis said second security gateway, via said layer 2 interface and said first secure tunnel, and with said authentication and security data, then to instruct the setting up of a second secure tunnel between said mobile terminal and said second security gateway, updating of mobility management information via the second secure tunnel, and activation of said layer 2 interface so that it proceeds to the transfer between said first and second wireless local area networks by sending said second security gateway, via said second secure tunnel, a peer address updating message in respect of the mobile terminal, then to authorize the call to continue via said second secure tunnel when said transfer has been completed.

7. A mobile communication terminal adapted to be connected to wireless local area networks using a wireless access technology to set up calls with a core network of a network offering packet-switched communication services and connected to said wireless local area networks, which terminal comprises at least one layer 2 interface and a management device claimed in claim 6.

8. The terminal claimed in claim 7, adapted to effect said pre-authentication procedure instructed by said device by means of a communication protocol dedicated to the creation of security associations.

9. The terminal claimed in claim 8, wherein said communication protocol is a protocol called IKE.

10. The terminal claimed in claim 8, adapted to transmit each peer address updating message by means of an extension of said communication protocol dedicated to mobility and to multi-homing.

11. The terminal claimed in claim 10, wherein said communication protocol extension is a protocol called MOBIKE.
